(19) United States
(12) Patent Application Publication
(10) Pub. No.: US 2008/0145136 A1
(43) Pub. Date: Jun. 19, 2008

(54) REVERSIBLE NIB

(76) Inventor: George Korper, Hendersonville, NC (US)

Correspondence Address: NOTARO AND MICHALOS, 100 DUTCH HILL ROAD, SUITE 110, ORANGEBURG, NY, 10962-2100, US

(21) Appl. No.: 11/611,395

(22) Filed: Dec. 15, 2006

(51) Int. Cl. B43K 8/06; B43K 5/00

(52) U.S. Cl. 401/198; 401/206; 401/205

(57) ABSTRACT

A nib arrangement has a reversible, elongated nib body of porous material with opposite substantially identical, shaped writing ends that are both shaped for depositing a fluid saturating the nib body, onto a surface as the writing end rubs along the surface, the nib body being structured to be reversibly mounted in an instrument for supplying the fluid to the nib with either writing end extending outwardly of the instrument.

### FIELD AND BACKGROUND OF THE INVENTION

The present invention relates in general to marking instruments, and, in particular, to a new and useful porous nib for receiving marking fluid such as paint or pigment carrying liquid, and for depositing that fluid onto a surface.

Marker and fluid depositing nibs are well known in the art. See for example U.S. Pat. No. 4,229,115 for a Nib for a Writing Instrument and U.S. Pat. No. 7,022,200 for a Method of Making Adhesive-Free Bonded Porous Thermoplastic Nibs . . . Also see the current inventor's U.S. Pat. No. 5,964,931 for a Correction Fluid Marker and Formulation for Fluid.

A specialized marker for use in refreshing the grout between tiles on a wall is marketed by the assignee of the present invention under the trademark GROUT-AIDE™. This marker-like product contains water-based paint and a nib that can be depressed by pushing the nib against the grout seam to be covered, then rubbing the nib along the seam. Pressing the nib opens a valve that allows a flow of paint to an end of the nib that is inside the marker housing so that the nib becomes saturated with paint and therefore applies the paint to the seam.

Due to the abrasive nature of the grout seam, the shaped writing end or point of the porous nib rather quickly wears out so that the marker becomes un-useable before all of the paint have been used up.

Nibs in all markers and like instruments have always been mounted as a fixed and permanent part of the instrument and, when the fluid was used up, or the nib was no longer operable, e.g. because it was worn down or worn to an un-useable shape, the instrument was discarded.

### SUMMARY OF THE INVENTION

It is an object of the present invention to provide a nib arrangement having an elongated nib body of porous material, the nib body having opposite substantially identical, shape writing ends that are both shaped for depositing a fluid saturating the nib body, onto a surface as the writing end rubs along the surface, the nib body being structured to be reversibly mounted in an instrument for supplying the fluid to the nib with either writing end extending outwardly of the instrument.

A further object of the invention is to provide such a reversible nib in combination with an instrument having a nib receiving opening for reversibly receiving and holding the nib body with either one of the writing ends extending outside the instrument, and the other one of the writing ends extending inside the instrument, the instrument including a reservoir communicating with the receiving opening and adapted to contain a fluid to be supplied to the nib body for application of the fluid to a surface by the one shaped writing end of the nib body that extends outside the instrument.

A still further object of the invention is to thereby provide a nib that substantially doubles the useful life of the instrument by allowing the nib to be reversed in the receiving opening after one of the initially substantially identical writing ends has worn out.

Although a marking fluid is given as an example of the fluid to be applied by the nib of the invention, it is understood that non-marking fluid may also by applied to a surface by the invention, e.g. clear antiseptic fluid on a wound, or clear anti-bacterial fluid on a surface to be cleaned.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partial sectional view of the reversible nib arrangement of the present invention showing a nib body and instrument for applying fluid;

FIG. 2 is a sectional view taken along line 2-2 of FIG. 1;

FIG. 3 is a partial view of FIG. 1 showing the instrument and nib in an open position for supplying fluid to the nib; and

FIG. 4 is a side view of another embodiment of the reversible nib of the present invention.

### DESCRIPTION OF THE PREFERRED EMBODIMENTS

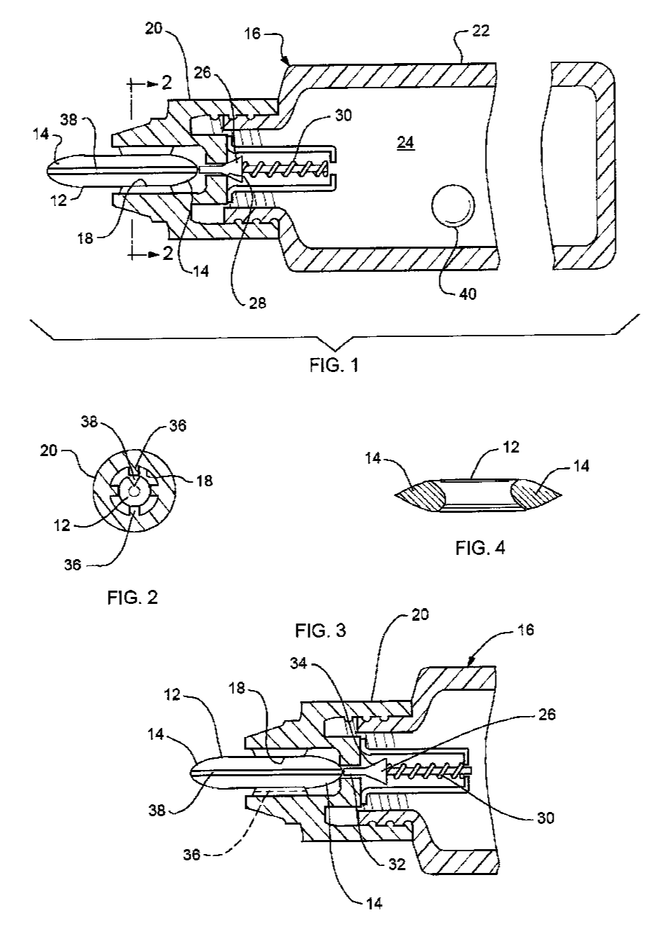

Referring now to the drawings, in which like reference numerals are used to refer to the same or similar elements, FIG. 1 shows a nib arrangement of the invention which includes an elongated, substantially cylindrical nib body 12 of porous material such as pultruded polyester. The nib body has opposite, substantially identical, shaped writing ends 14 that a re both shaped for depositing a fluid saturating the nib body, onto a surface as the writing end rubs along the surface. The shape may be substantially conical or tapered to a rounded termination or point as shown in FIG. 1, or chisel shaped as shown in FIG. 4, or have any other special shape that is known by those skilled in the art for laying a fluid onto a surface.

For the purpose of this disclosure the terms conical or tapered are used to describe any shape that becomes smaller toward the end of the nib body and the term chisel shaped is used to describe any shaped writing end that has at least one straight edge that extends at any right or acute angle to the axis of the elongated nib body.

The nib body 12 is structured to be reversibly mounted in an instrument 16 for supplying the fluid to the nib, with either writing end 14, 14 extending outwardly of the instrument.

The instrument 16 has a nib receiving opening or passage 18 defined for example, in a screwed on end cap 20 of the instrument, for reversibly receiving and holding the nib body 12, with either one of the writing ends 14 extending outside the instrument, and the other one of the writing ends 14 extending inside the instrument. The instrument 16 includes a main section 22 onto which the cap 20 is screwed, with a reservoir 24 communicating with the receiving opening or passage 18. Reservoir 24 is adapted to contain a fluid, e.g correction fluid, grout covering fluid, paint, marker fluid, or any other fluid to be applied by the nib. The fluid can thus be supplied to the nib body for application of the fluid to a surface by the one writing end of the nib body that extends outside the instrument.

A valve made up of a movable and biased valve member 26 and a valve seat 28, is provided between the reservoir 24 and the receiving opening 18. The valve is engagable by the nib for opening the valve against the bias of a spring 30, to pass fluid from the reservoir 24 to the nib 12 in the receiving opening 18 as shown in FIG. 3. For this purpose, the inside shaped writing end 14 of nib 12 engages a forwardly projecting end 32 of valve member 26, and, when the opposite outside shaped writing end 14 is being pressed against a surface, the valve member 26 is pushed against the bias of spring 30 to the right in FIG. 3, to move a conical closing portion 34 of member 26 away from the circular valve seat 28. This opens communication between reservoir 24 and passage 18 so that the fluid can flow in the direction of the arrows in FIG. 3, to soak the porous nib 12. One or more metal balls 40 or other free moving mixing elements are advantageously included in reservoir 24 to help mix the fluid.

Circumferentially spaced ribs 36 in passage 18, fictionally engage the outer surface of nib 12 to hold the nib body in a removable but secure fashion, in the nib receiving opening 18, so that the nib does not fall out in use, but can be pulled out, turned 180 degrees and reinserted into passage 18 when the outside one of the writing ends 14 has worn out so that the other end can be used. This doubles the useful life of the instrument.

To better channel fluid along the entire length of nib body 12, the body may include a V-shaped groove 38 that extends between the writing ends 14, 14. The groove 38 may have another shape and there may be more than one groove along the nib body. In the embodiment shown the groove has a depth of about 20 to 60% of the nib body diameter, with an advantageous depth being about one third of the nib body diameter.

While specific embodiments of the invention have been shown and described in detail to illustrate the application of the principles of the invention, it will be understood that the invention may be embodied otherwise without departing from such principles.

What is claimed is:

1. A nib arrangement comprising: an elongated nib body of porous material, the nib body having opposite substantially identical, shaped writing ends that are both shaped for depositing a fluid saturating the nib body, onto a surface as the writing end rubs along the surface, the nib body being structured to be reversibly mounted in an instrument for supplying the fluid to the nib with either writing end extending outwardly of the instrument.

2. A nib arrangement according to claim 1, wherein the nib body includes a groove extending between the opposite writing ends.

3. A nib arrangement according to claim 1, wherein the opposite writing ends are each substantially conical in shape.

4. A nib arrangement according to claim 1, wherein the nib body is substantially cylindrical and includes a substantially V-shaped groove extending between the opposite writing ends, each of the writing ends being tapered to a rounded termination.

5. A nib arrangement according to claim 1, wherein the nib body is made or porous polyester.

6. A nib arrangement according to claim 1, wherein the opposite writing ends are each substantially conical, the nib body being made or pultruded porous polyester.

7. A nib arrangement according to claim 1, wherein the opposite writing ends are each substantially conical, the nib body being made or pultruded porous polyester and having a groove extending between the opposite writing ends.

8. A nib arrangement according to claim 1, including, in combination with the nib body, an instrument having a nib receiving opening for reversibly receiving and holding the nib body with either one of the writing ends extending outside the instrument, and the other one of the writing ends extending inside the instrument, the instrument including a reservoir communicating with the receiving opening and adapted to contain a fluid to be supplied to the nib body for application of the fluid to a surface by the one shaped writing end of the nib body that extends outside the instrument.

9. A nib arrangement according to claim 1, including, in combination with the nib body, an instrument having a nib receiving opening for reversibly receiving and holding the nib body with either one of the writing ends extending outside the instrument, and the other one of the writing ends extending inside the instrument, the instrument including a reservoir communicating with the receiving opening and adapted to contain a fluid to be supplied to the nib body for application of the fluid to a surface by the one shaped writing end of the nib body that extends outside the instrument, and a valve between the reservoir and the receiving opening that is engagable by the nib for opening the valve to pass fluid from the reservoir to the nib in the receiving opening.

10. A nib arrangement according to claim 1, wherein the opposite writing ends are each substantially chisel shaped.

11. A nib arrangement comprising
an elongated nib body of porous material, the nib body having opposite substantially identical, shaped writing ends that are both shaped for depositing a fluid saturating the nib body, onto a surface as the writing end rubs along the surface, the nib body being structured to be reversibly mounted in an instrument for supplying the fluid to the nib with either writing end extending outwardly of the instrument, and
an instrument having a nib receiving opening for reversibly receiving and holding the nib body with either one of the writing ends extending outside the instrument, and the other one of the writing ends extending inside the instrument, the instrument including a reservoir communicating with the receiving opening and adapted to contain a fluid to be supplied to the nib body for application of the fluid to a surface by the one end of the nib body that extends outside the instrument.

12. A nib arrangement according to claim 11, including a valve between the reservoir and the receiving opening that is engagable by the nib for opening the valve to pass fluid from the reservoir to the nib in the receiving opening.

13. A nib arrangement according to claim 11, wherein the nib body includes a groove extending between the opposite writing ends.

14. A nib arrangement according to claim 11, wherein the opposite writing ends are each substantially conical in shape.

15. A nib arrangement according to claim 11, wherein the nib body is substantially cylindrical and includes a substantially V-shaped groove extending between the opposite writing ends, each of the writing ends being tapered to a rounded termination.

16. A nib arrangement according to claim 11, wherein the nib body is made or porous polyester.

17. A nib arrangement according to claim 11, wherein the opposite writing ends are each substantially conical, the nib body being made or pultruded porous polyester.

18. A nib arrangement according to claim 11, wherein the opposite writing ends are each substantially conical, the nib body being made or pultruded porous polyester and having a groove extending between the opposite writing ends.

19. A nib arrangement according to claim 11, wherein the opposite writing ends are each substantially chisel shaped.
